(19) United States
(12) Patent Application Publication
(10) Pub. No.: US 2013/0117681 A1
(43) Pub. Date: May 9, 2013

(54) Method and Apparatus for Targeting Updated Personal Data to Providers

(71) Applicant: Sylvain Veys, Evanston, IL (US)

(72) Inventor: Sylvain Veys, Evanston, IL (US)

(21) Appl. No.: 13/732,872

(22) Filed: Jan. 2, 2013

(51) Int. Cl. G06F 3/048

(52) U.S. Cl. CPC G06F 3/048
USPC 715/739

(57) ABSTRACT

A method and apparatus for targeting updated personal data to providers, performed in an electronic device having a display screen, the method including displaying an indication of an update application, on the display screen, for user selection, displaying personal data obtained by the update application on the display screen, receiving updated personal data input by a user as updated personal data, receiving at least one target provider input by a user as selected target provider/s, and initiating transmission of the updated personal data to each selected target provider.

### FIELD OF THE DISCLOSURE

The present disclosure relates generally to features for electronic devices and more particularly to a method and apparatus for targeting updated personal data to providers.

### BACKGROUND

Conventional customer and provider relationships require much upfront transfer of personal information from the customer to the provider. The customer typically is required to provide personal data such as: name, address, phone, email, age, social security information, and credit card information. Providers include service providers or product or utility providers, such as: telephone companies, mortgage providers, electric energy companies, gas companies, water companies, banks, grocery stores, employers, schools, universities, insurance companies, PayPal, jewelry stores, department stores, boutiques, pet agencies, child care provider services, etc. Whenever a business relationship is established an initial transfer of personal information from the customer to the provider is made.

When the customer changes some personal information, the customer must locate each telephone or email of the providers so he may call or email the provider with his updated personal information. This procedure is cumbersome as most customers have multiple providers to update.

Accordingly, there is a need for a method and apparatus for targeting updated personal data to providers.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an electronic device including an update personal data application in accordance with some embodiments of the present disclosure.

FIGS. 2-8 are schematics of a visual interface instances in accordance with some embodiments of the present disclosure.

FIG. 9 is a block diagram of software and hardware components in accordance with embodiments of the present disclosure.

FIGS. 10A-10B is a flowchart of a method for targeting updated personal data to providers in accordance with some embodiments of the present disclosure.

FIG. 11 is an example update application message in accordance with some embodiments of the present disclosure.

FIG. 12 is a block diagram of a general network environment in which targeting updated personal data to providers is performed in accordance with some embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, a user stores any personal contact, personal financial, and personal bill payment information, and an update application stores and/or monitors for any updates to the information, and provides a user a tool for sending notifications to providers or other targets that the user would like to receive the updated information. The platform that may implement the application may be a desktop electronic device or a mobile electronic device.

In one example embodiment, a method provides for targeting updated personal data to providers, performed in an electronic device having a display screen, the method including displaying an indication of an update application, on the display screen, for user selection, displaying personal data obtained by the update application on the display screen, receiving updated personal data input by a user as updated personal data, receiving at least one target provider input by a user as selected target provider/s; and initiating transmission of the updated personal data to each selected target provider.

In another embodiment, an electronic device provides for targeting updated personal data to providers, the electronic device including a processor, memory coupled to the processor, wherein the memory is configured to store an update application and personal data, a visual interface coupled to the processor, wherein the visual interface is configured to display data from the update application, wherein the data includes personal data and at least one target provider, a user input device coupled to the processor, wherein the user input device is configured to receive as input at least one updated personal data and at least one selected target provider as input to the update application, wherein the processor is configured to initiate transmission of the updated personal data to the at least one selected target provider.

In another example embodiment, a method provides for targeting updated personal data to providers, performed in an electronic device having a display screen, the method including displaying an indication of an update application, on the display screen, for user selection, displaying personal data obtained by the update application on the display screen, receiving updated personal data input by a user as updated personal data, receiving at least one target provider input by a user as selected target provider/s, initiating transmission of the updated personal data to each selected target provider, wherein the personal data is associated with a personal data tag; and displaying a transmission application selection to the user to be used when initiating transmission of the updated personal data to each selected target provider.

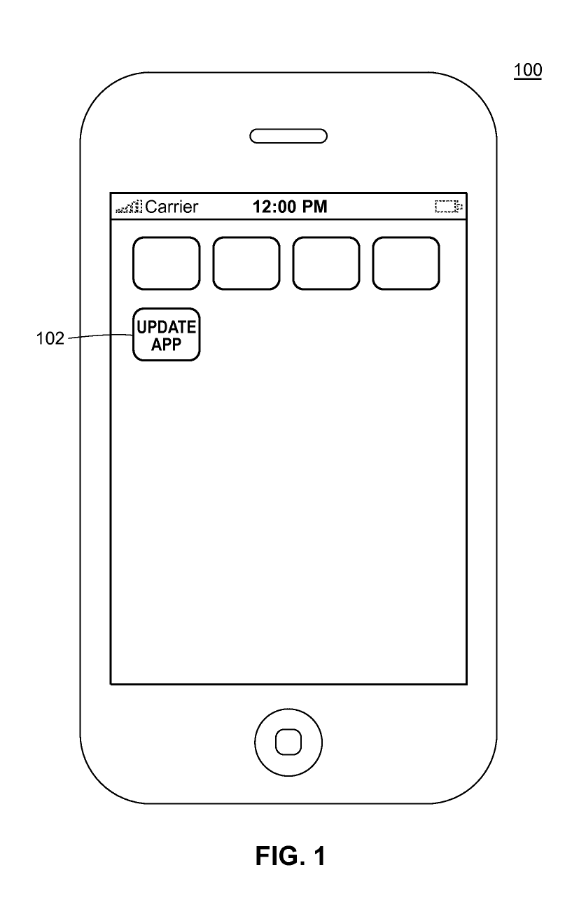

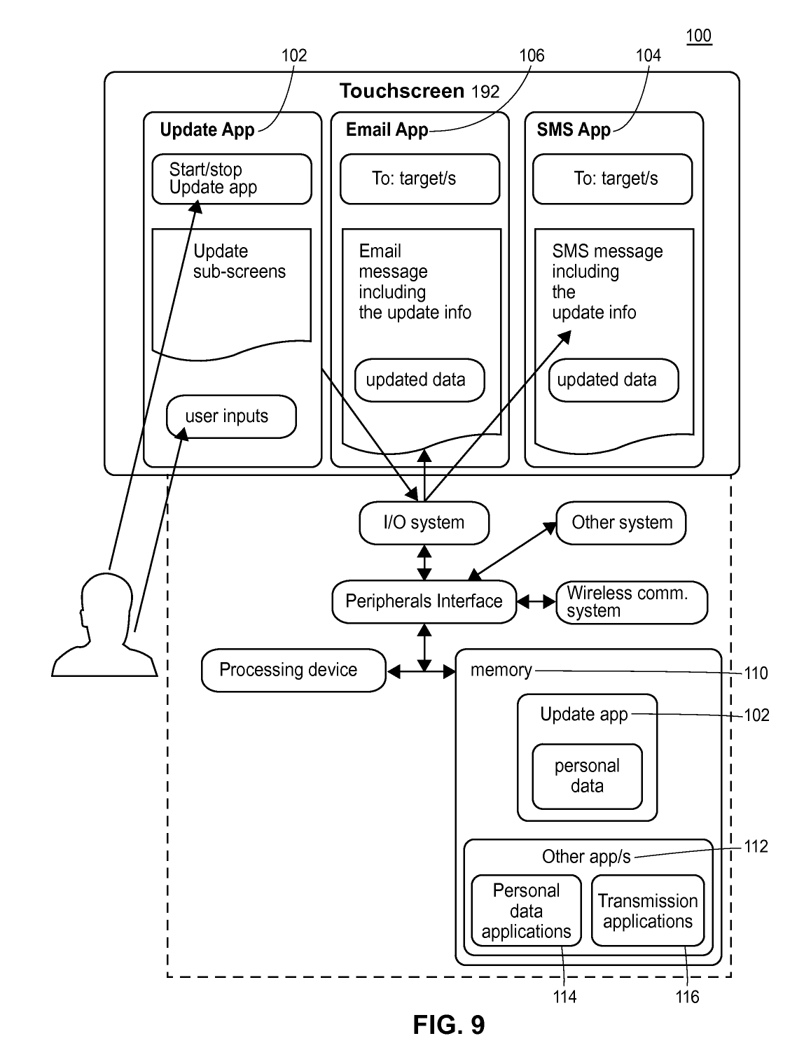

Referring now to the drawings, and in particular FIG. 1 and FIG. 9, an electronic device, such as a mobile electronic device 100 including one or more software or mobile applications and further including an update application 102 is shown. In an embodiment, the mobile electronic device 100 includes one or more additional components found in a portable wireless communication device but not shown, including, but not limited to: additional Input/Output (I/O) devices (e.g., a keyboard, speakers, microphones, etc.), a GPS circuit/module, etc., that operate together and are configured to provide a user with electronic device functionality.

“Adapted,” “operative” or “configured” as used herein means that the indicated elements are implemented using one or more memory devices, interfaces, and/or processing devices that are operatively coupled. The memory devices, interfaces, and/or processing devices, when programmed, form the means for these system elements to implement their desired functionality.

In an embodiment, the electronic device 100 is a portable wireless communication device such as a cellular telephone, a smartphone, a personal data assistant (PDA), etc. Those skilled in the art, however, will recognize and appreciate that the specifics of this example are merely illustrative of some embodiments and that the teachings set forth herein are applicable in a variety of alternative settings. For example, since the teachings described do not depend on the electronic device or data presentation applications, they can be applied to any type of electronic device having different types of data presentation applications stored thereon. As such, other alternative implementations of using different types of electronic devices including desktop and laptop computers and data presentation applications that can recognize data as a standalone object that can be exported to a different application are contemplated and are within the scope of the various teachings described.

Turning back to the description of the elements shown in FIG. 1 and FIG. 9, the electronic device 100 further has stored therein (e.g., in the memory 110) other applications 112 that include personal data storage applications 114, such as a contacts application, notes application, Evernote application, word processing application, etc., or any personal data information storage application 114; and one or more transmission applications 116 for transmitting updated personal data as initiated by an update application 102. Transmission applications 116 include any conventional or future transmission applications, such as a short message service (SMS) application 104, an email application 106, etc.

Each application 102, 104, 106, 112, 114, and 116, etc. includes software having code or logic instructions that when executed by the processing device 190 visually provides data to a user via (i.e., using) a visual interface such as the touch screen display 192. In the embodiment shown in FIG. 1 and FIG. 9, it should be noted that any combination of the applications could be stored in the electronic device 100. Moreover, one or more additional or alternative data storage application or data transmission application (not shown) may be stored in the electronic device 100.

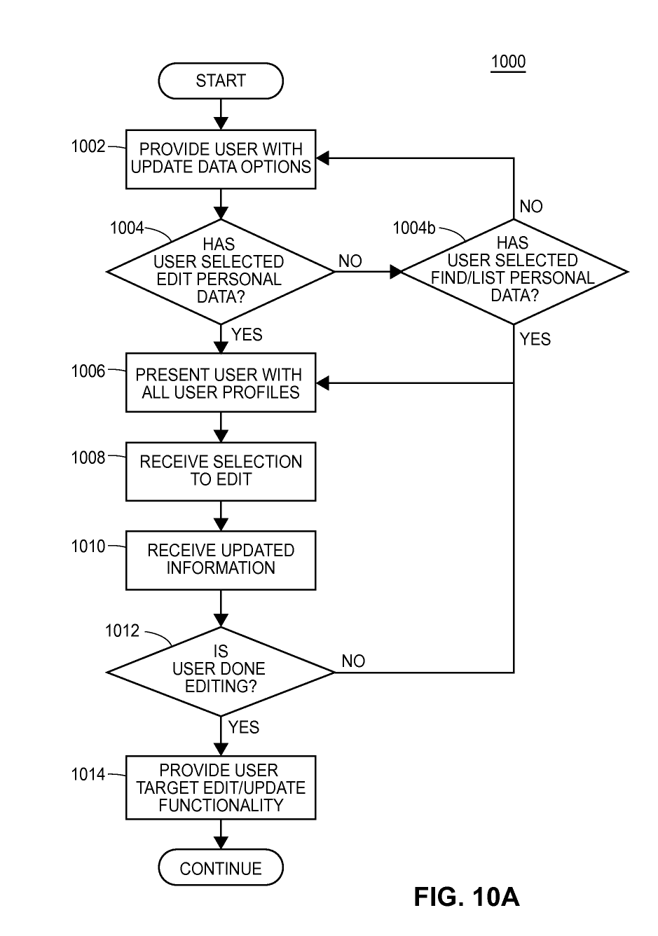

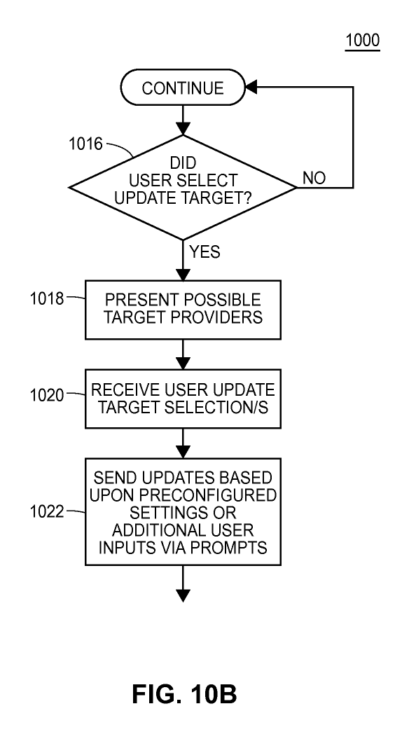

Returning now to the description of the update application 102 with the assistance of the example schematics of FIGS. 1-8 and example flow diagram of FIGS. 10A-1B, in an embodiment, the update application 102 may be selected by the user and executed by the processing device 190 to present on the display (e.g. touchscreen 192, FIG. 9) at least one (i.e., one or more) update data options. Example update data options include a find or list personal data selection 202, an edit personal data selection 204, an edit target provider selection 206, and an update target provider selection 208. As used herein, a “selection” includes a user input that initiates the described function of the update application, such as a touchscreen button, click, keypad entry, command text, etc., or any other type of user input.

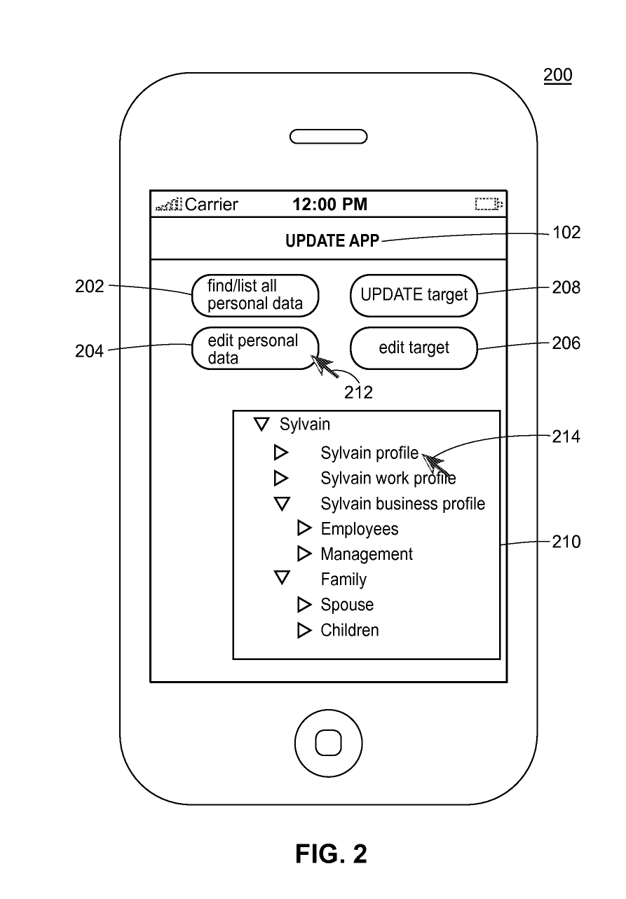

“Personal data” means alphanumeric text or characters, which may be a sequence or combination of words and/or numeric values, which the user has indicated as being personal data. A user may indicate such data as being personal data by storing the data in a particular storage location where personal data is typically kept, such as a contacts storage, etc. A user may indicate such data as being personal data by associating a personal data tag to the particular data. Personal data includes, for example, any one or more from the following: name, social security number, address, telephone, driver license, or any other identification information, etc. Personal data may be stored in profile groupings, such as work profile, home profile business profile, family profile, etc., as shown in FIG. 2, or other hierarchal structures.

Update application 102 presents the user with the update data options, which include edit personal data option 204, find/list all personal data option 202, update target 206, and edit target 208. Update application 102 monitors for a user input (FIG. 10A, 1004). If the user selects to edit personal data, the update application 102 presents the user with the user profiles (1004->1006). Otherwise, the update data application 102, checks for the other possible user inputs, such as whether the user selected any of the other updates data options, find/list all personal data option 202 (1004b), update target 206 (not shown in FIG. 10), and edit target 208 (not shown in FIG. 10). Any of the update data options may be initiated at any time and may be initiated with updated and stored information.

When the update personal data application 102 receives (1008) a user selection to edit personal data, for example when the user selects the edit personal data option 204 (e.g., as indicated in FIG. 2, selecting 212 edit personal data button), the update data application presents (1006) an example visual interface that includes a view of the personal data, such as the personal data viewing window 210, including all or some of the user personal data and profiles that may exist. The user may scroll through the personal data view 210. In FIG. 2 the user is shown selecting 214 to edit his personal profile information.

Throughout the interface descriptions corresponding to FIGS. 1-8, pointers are used to show user selections for ease of understanding. In the mobile application embodiment of the update application 102, the pointers are used to visually indicate a user's touchscreen input, e.g., user touching the screen with his finger/s. Other input methods are also included, such as mouse pointers, pen instrument inputs, etc.

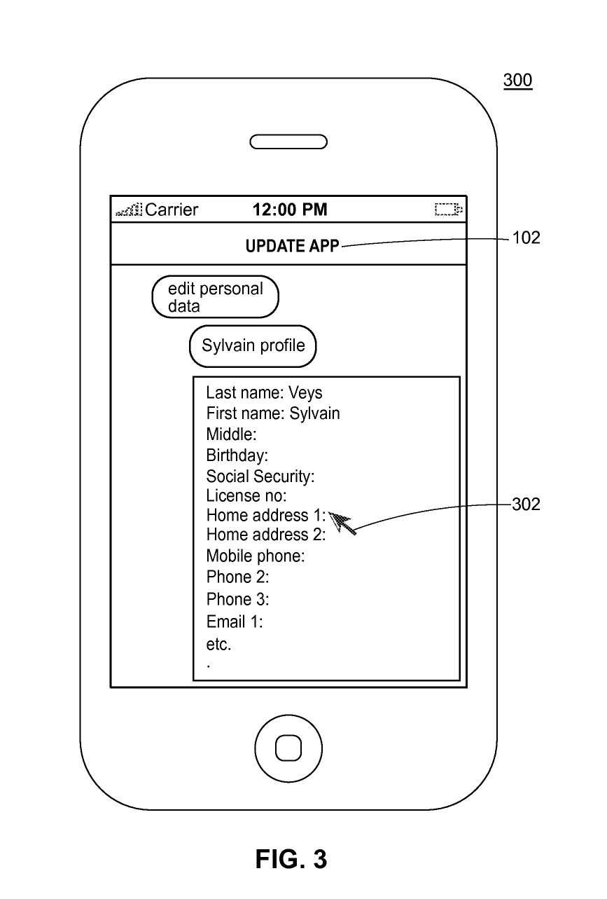

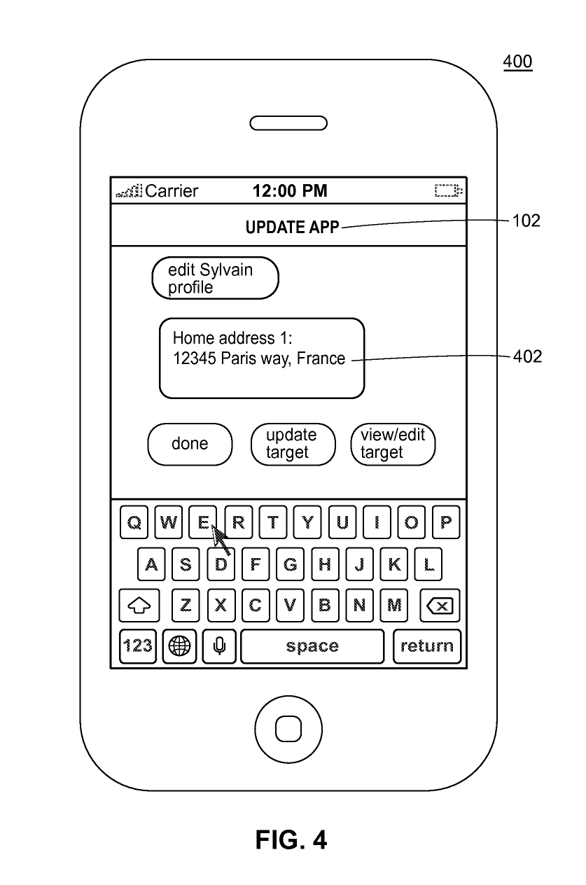

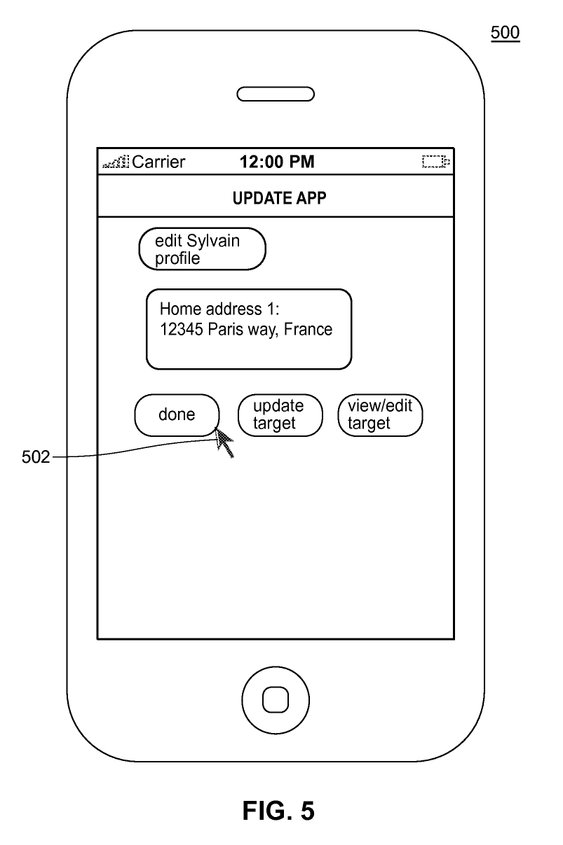

The update data application 102 monitors for user input to determine which personal data the user has selected to edit (1008). The user may select to edit any personal data, for example, such as the user selects (e.g., as indicated in FIG. 3, 302) to edit his “home address 1.” The user edits (e.g., as indicated in FIG. 4, 402) the selected personal data. The update application 102 checks (1012) when the user is done editing the data. For example, the user may indicate completion of editing by selecting a done button, e.g., as indicated the selection 502 in FIG. 5.

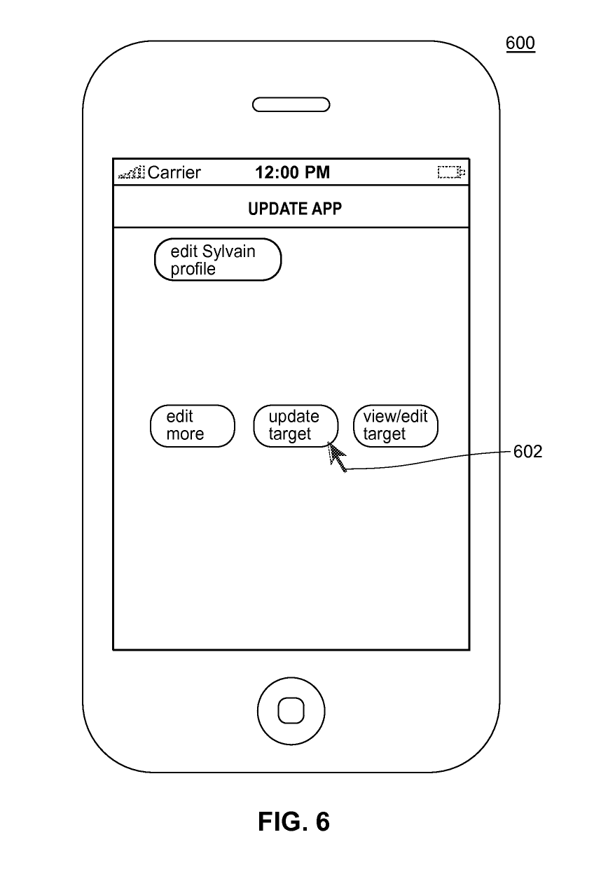

The update application 102 provides (1014) the user with the update data options including, as described above, the edit target 206 and update target 208 selections. The update application 102 checks (1016) for a user selection of update target provider indication (e.g., as indicated in FIG. 6, selecting 602 an update target provider data button). FIG. 6 shows the option to update the target being presented after personal data was edited. Personal data may be edited and saved for later transmission. For example, the update target option may be provided at any later time, by for example the update target selection 208 as presented in FIG. 2. In such case, the corresponding flow diagram would include the following: receive updated information (e.g. 1010) and store the updated personal information (not shown), present possible target providers (e.g., 1018), receive user update target selections (e.g., 1020), and send updates (e.g., 1022) based upon preconfigured settings or additional user inputs via prompts.

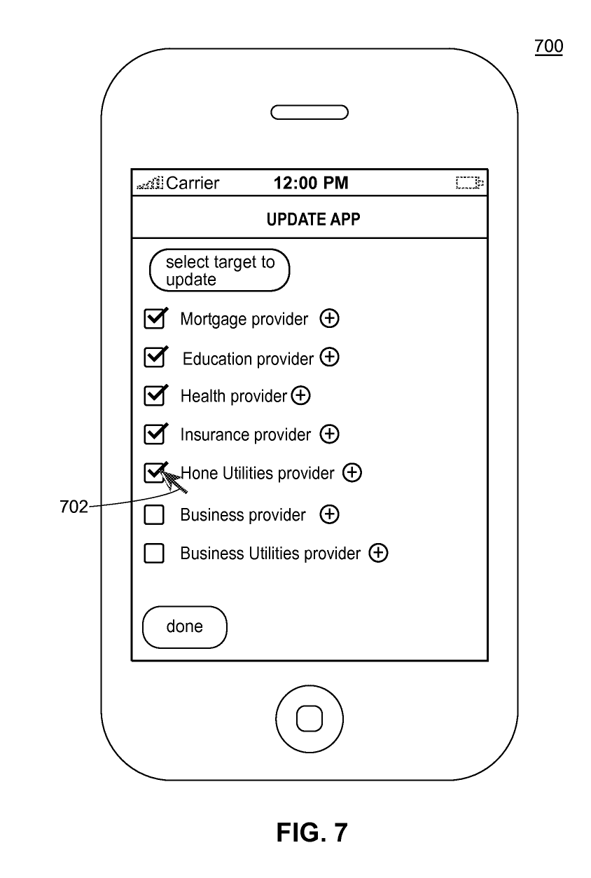

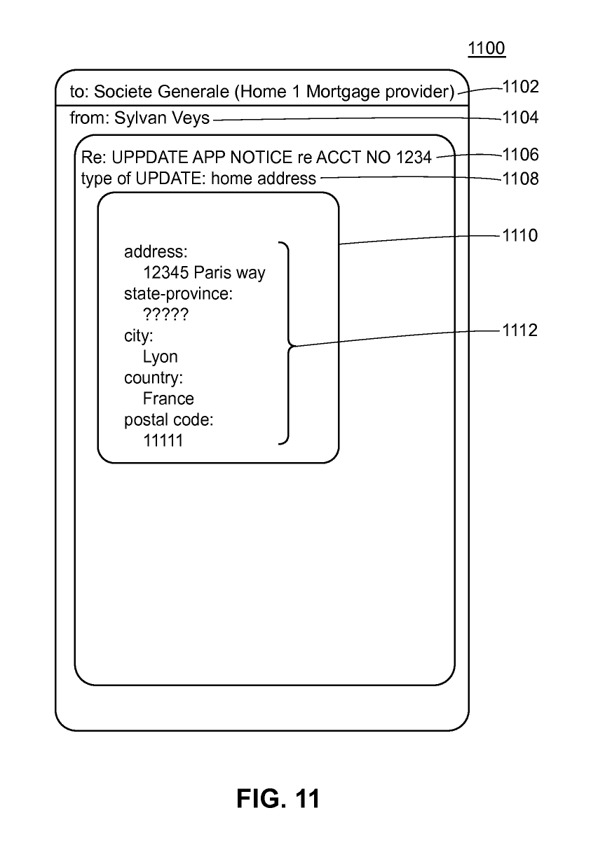

Referring back to the present example, the update application 102 presents the user with a list of target providers (1018, see screen 700 of FIG. 7) for selection to send the updated personal data information. The update data application 102 receives (1020) the user selection of which one or more target provider/s to update. For example, the user may click on one or more boxes associated with each selected target provider (702). Having the updated personal data information and the user selections as to which target provider/s are to be updated, the update application 102 sends (1022) one or more updates (e.g., UPDATE APP NOTICE of FIG. 11) to the selected target provider/s.

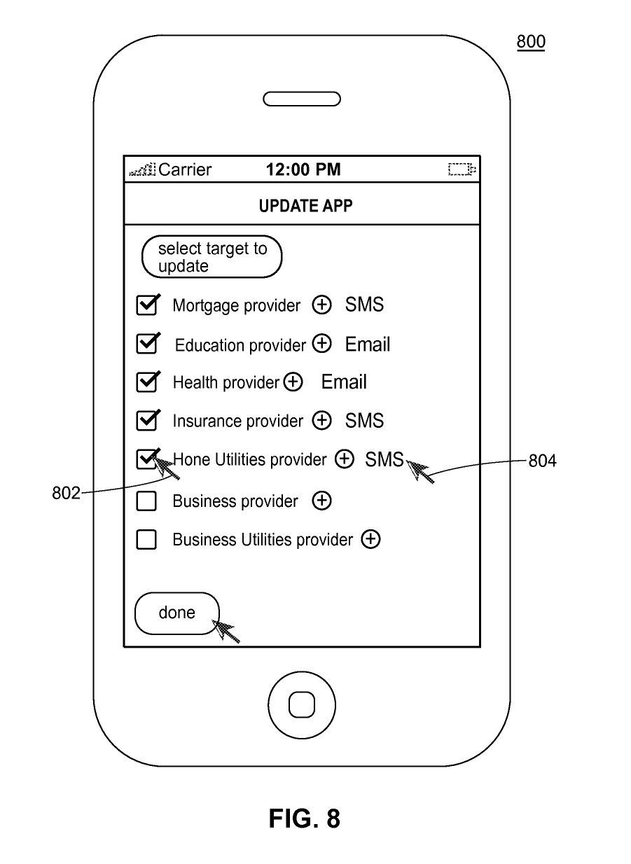

Alternatively or additionally, the user may be prompted (1022) as to which transmission application should be used to send the update to the target provider for each target provider or for all targeted providers (not shown). For example, FIG. 8 shows selections as to which transmission application is to be used when sending an update for each different target provider. In particular, when a user selects 802 a target provider, such as “Home utilities provider,” the user is presented with a drop down list (not shown) of the available transmission applications 116. In FIG. 8 the user is shown choosing an SMS application 104 as the transmission application 116 to be used when updating the “Home utilities provider” target provider. Other transmission applications 116 that are not shown may also be used, such as voice memos, automated voice message calls, etc.

FIG. 11 illustrates an example of an update message 1100 and its contents. An update message may be sent with any type of transmission application 116 and its corresponding information structure. FIG. 11 shows a typical email application 106 and its content including a target email address 1102, sender information 104, a message identification 1106, a sub-type of message indication 1108, and updated personal data content 1112.

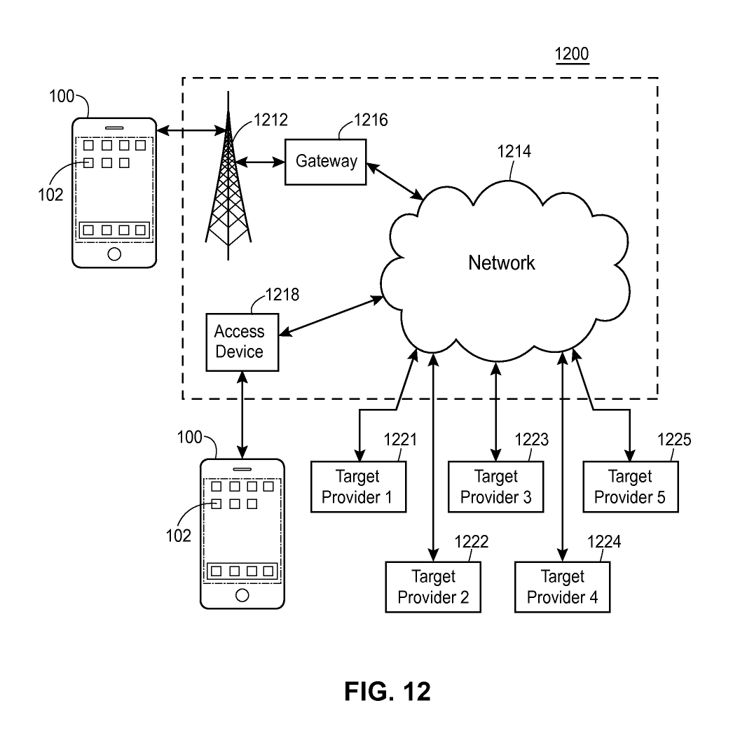

FIG. 12 is a block diagram of a general network environment 1200 in which targeting updated personal data to providers is performed in accordance with some embodiments of the present disclosure. For example electronic device 100 may be a smartphone that communicates over one or more wired or wireless networks. For example, a wireless network may include cellular network 1212, which communicates with a wide area network (WAN) 1214, such as the Internet, by use of a gateway 1218. An access device 1218, such as an 802.11 wireless access device, provides access to the wide area network 1214. The update application 102 initiates transmission of an update message (e.g., 1100) via the user selected transmission applications 116 to any one or more of the selected target providers 1221-122n.

In another embodiment, the update application 102 may provide the user a personal data tag which the user may use to tag any data in any other application that is stored in the electronic device 100 or remotely. For example, a user may start and keep the update application 102 open while using another application, such as a note, or evernote application, where the user stores personal information. A user may tag any personal data, stored locally or remotely, with a personal data tag made available by the update application 102 and then may store the data with the tag. The update application 102 may provide a user with a find personal data 202 selection, which searches through all the memory of the electronic device 100 and/or any remotely stored data, such as files stored on a Drop box location service. A personal data tag software module (not shown) provides the user a personal data tag to associate to data a user identified as being personal data. The personal data tag software module is configured to search through data of other applications stored on the electronic device to find the associated personal data to present the associated personal data to the user on the display screen or remotely stored data. A personal data tag software module may be stored as a software function of the update application 102 or it may be a standalone module that may be stored in the electronic device 100 for access by other applications and other integration configurations.

Programming techniques such as extensible markup language, (XML), which is a language similar to HTML used for creating arbitrarily-structured documents and web pages, or other similar data techniques, which may exchange data between different systems may be used with the herein described methods and apparatus. Any Internet or wireless transportation protocol may be used with an embodiment of the invention described herein. When the target providers use similar transmission applications as the transmission application 116 selected for use by the update application 102, then the exchange of data may be more efficient. In cases where the selected target provider, e.g., 1221 does not use the same transmission application 116, then a standardized uniform general data format may be specified by the user or by the update application 102 for interoperability.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for targeting updated personal data to providers, performed in an electronic device having a display screen, the method comprising:
displaying an indication of an update application, on the display screen, for user selection;
displaying personal data obtained by the update application on the display screen;
receiving updated personal data input by a user as updated personal data;
receiving at least one target provider input by a user as selected target provider/s;
initiating transmission of the updated personal data to each selected target provider.

2. The method of claim 1, wherein the personal data is associated with a personal data tag.

3. The method of claim 1 further comprising
a personal data tag software module that provides the user a personal data tag to associate to data a user identified as being personal data,
wherein the personal data tag software module is configured to search through data of other applications stored on the electronic device to find the associated personal data to present the associated personal data to the user on the display screen.

4. The method of claim 1 further comprising
providing a personal data search button configured to search a memory of the electronic device for data associated with the personal data tag.

5. The method of claim 1 further comprising
a personal data tag software module that provides the user a personal data tag to associate to data that a user identified as being personal data,
wherein the personal data tag software module is configured to search through data of other applications stored on the electronic device or remotely to find the associated personal data to present the associated personal data to the user on the display screen;
wherein the personal data tag is used with XML programming techniques.

6. The method of claim 1 further comprising
providing a personal data list or a personal data search button.

7. The method of claim 1 further comprising
displaying a transmission application selection to the user to be used when initiating transmission of the updated personal data to each selected target provider.

8. The method of claim 1 further comprising
displaying a transmission application selection, for each selected target provider, to the user to be used when initiating transmission of the updated personal data for each selected target provider.

9. The method of claim 1 further comprising
exporting the updated personal data to an application programming interface.

10. An electronic device for targeting updated personal data to providers, the electronic device comprising:
a processor;
memory coupled to the processor, wherein the memory is configured to store an update application and personal data;
a visual interface coupled to the processor, wherein the visual interface is configured to display data from the update application, wherein the data includes personal data and at least one target provider;
a user input device coupled to the processor, wherein the user input device is configured to receive as input at least one updated personal data and at least one selected target provider as input to the update application;
wherein the processor is configured to initiate transmission of the updated personal data to the at least one selected target provider.

11. The electronic device of claim 10, wherein the visual interface and the user input comprise a touch screen display.

12. The electronic device of claim 10, wherein the electronic device is a portable wireless communication device.

13. The electronic device of claim 10, wherein the update application includes a transmission module configured to export the updated personal data to at least one of the selected target provider using a first application, a second application, or an application programming interface.

14. The electronic device of claim 10, wherein the update application includes a transmission module configured to export the updated personal data to at least one of the selected target provider using a short message service application, or an email application, or an application programming interface configured to interface with an other application.

15. The electronic device of claim 14, wherein the personal data is associated with a personal data tag.

16. The electronic device of claim 10, wherein the memory includes a personal data tag software module that provides the user a personal data tag to associate to data a user identified as being personal data,
wherein the personal data tag software module is configured to search through data of other applications stored on the electronic device to find the associated personal data to present the associated personal data to the user on the visual interface.

17. The electronic device of claim 13, wherein the transmission module is further configured to prompt the user for transmission selections for each selected target provider.

18. The electronic device of claim 14, wherein the transmission module is further configured to prompt the user for transmission selections for each selected target provider.

19. The electronic device of claim 14, wherein the transmission module is further configured to prompt the user for transmission selections for each selected target provider, wherein the transmission selections correspond to other applications stored on the memory or remotely.

20. A method for targeting updated personal data to providers, performed in an electronic device having a display screen, the method comprising:
displaying an indication of an update application, on the display screen, for user selection;
displaying personal data obtained by the update application on the display screen;
receiving updated personal data input by a user as updated personal data;
receiving at least one target provider input by a user as selected target provider/s;
initiating transmission of the updated personal data to each selected target provider;
wherein the personal data is associated with a personal data tag; and
displaying a transmission application selection to the user to be used when initiating transmission of the updated personal data to each selected target provider.
